(19) United States
(12) Patent Application Publication
(10) Pub. No.: US 2012/0142468 A1
(43) Pub. Date: Jun. 7, 2012

(54) ROLLING BEARING FOR TENSIONING ROLLER DEVICE AND ASSOCIATED TENSIONING ROLLER

(75) Inventors: Romuald LESCORAIL, Saint Laurent en Gatines (FR); Eric ROBERT, SAINT CYR SUR LOIRE (FR)

(73) Assignee: AKTIEBOLAGET SKF, Goteborg (SE)

(21) Appl. No.: 13/308,589

(22) Filed: Dec. 1, 2011

(30) Foreign Application Priority Data
Dec. 7, 2010 (FR) 1060189

(51) Int. Cl. F16H 7/12; F16H 7/08; F16C 33/72; F16C 33/58; F16C 19/08

(52) U.S. Cl. 474/136; 384/513; 384/512; 384/477; 474/101

(57) ABSTRACT

Rolling bearing, for a tensioning roller, comprising an inner race, an outer race mounted so as to rotate about the inner race and at least one row of rolling elements placed between the inner race and outer race, the said inner race comprising an axial portion extending axially beyond the outer race.

The rolling bearing comprises an insert fitted into an open-ended bore made in the axial portion of the inner race.

### CROSS-REFERENCE

This application claims priority to French Application No. FR1060189 filed on Dec. 7, 2010.

### FIELD OF THE INVENTION

The present invention relates to the field of rolling bearings for tensioning roller devices designed to interact with a chain or a belt. Tensioning rollers are usually used to adjust and constantly maintain a tension on a belt within a determined range or to modify the orientation of the strands of a belt.

### BACKGROUND OF THE INVENTION

Such rollers are notably used, for example, with timing belts or belts for driving accessories, in an internal combustion heat engine of a motor vehicle, for example.

The invention relates more particularly to the tensioning rollers comprising a pulley mounted rotatably on a non-rotating spindle or shaft that can be moved radially so that the pulley applies an appropriate tension to the belt with which it is in contact. The radial movement of the spindle or the shaft can be adjusted by a screw mechanism interacting with a tapped hole made directly on the non-rotating spindle or shaft interacting with a threaded rod mounted on the engine.

For this purpose it is possible to refer to French patent application FR 2 907 526 (SKF) which describes an tensioning roller device comprising a non-rotating portion around which is rotatably mounted a rotating portion forming a pulley and between which elements are placed two rows of rolling elements. The non-rotating portion comprises an axial portion in which a tapped radial hole is made interacting with a threaded rod mounted on the engine so as to move the tensioning roller device radially and to adjust the tension of the belt of the engine.

However, when the threading is machined in the thickness of the non-rotating portion, burrs may appear on the sides of the thread. Moreover, since the threading tolerances are difficult to maintain, a defect of perpendicularity may appear between the axis of the rolling bearing and the axis of the tapped hole.

Moreover, the surface treatment conventionally carried out on the non-rotating portion, forming the inner race of the rolling bearing, may cause a weakness or even a breakage of the threading.

The failure of a belt, in particular of a timing belt of a motor vehicle heat engine may cause considerable damage to the engine and compromise operating safety.

The object of the present invention is to alleviate the drawbacks of the prior art.

The object of the invention is to propose a rolling bearing for tensioning roller devices making it possible to ensure a good perpendicularity between the axis of the tapped hole and the axis of the rolling bearing while being simple to manufacture and assemble.

### SUMMARY OF THE INVENTION

The subject of the invention is a rolling bearing, notably for an tensioning roller, comprising an inner race, an outer race mounted so as to rotate about the inner race and at least one row of rolling elements placed between the inner and outer races. The said inner race comprises an axial portion extending axially beyond the outer race.

The rolling bearing comprises an insert fitted into an open-ended bore made in the axial portion of the inner race.

Therefore, the threading operations are not carried out directly on the inner race. Moreover, the mounting of the insert on the inner race can be carried out after the surface treatment of the latter, and notably after the assembly of the other elements of the rolling bearing, which reduces the risk of a defect of perpendicularity between the axis of the rolling bearing and the axis of the threaded rod interacting with the insert. The tolerances of the threading made in the insert are also more easily maintained.

Advantageously, the axis of the open-ended bore is oriented perpendicularly to the axis of the rolling bearing so that the insert is oriented perpendicularly to the axis of the rolling bearing.

In one embodiment, the insert comprises a bore comprising a threaded central portion extended radially on the side of each end by a smooth zone of greater diameter than the threaded portion.

The bore of the insert may also be tapped over the whole of its length.

The rolling bearing may comprise two rows of rolling elements.

Preferably, the rolling bearing comprises sealing means placed between the outer and inner races on each side of the rolling elements.

Preferably, the outer race has an outer surface comprising channels designed to interact with a pulley.

Advantageously, the rolling bearing comprises means for attaching the insert in the inner race allowing the anti-rotation and the axial retention of the insert.

The insert may comprise, at each of its ends, recesses designed to interact with a crimping tool, or be attached to the inner race by braising, welding, bonding or forced sleeve-fitting in the inner race.

According to another aspect, an tensioning roller device is also proposed comprising a rolling bearing, and a pulley overmolded onto the outer race.

Advantageously, the insert is adapted to interact with a threaded rod for the purpose of moving, radially relative to the axis of the rolling bearing, the tensioning roller.

### BRIEF DESCRIPTION OF THE DRAWINGS

Other objects, features and advantages of the invention will appear on reading the following description given only as a non-limiting example and made with reference to the appended drawings in which:

FIG. 1 is a view in axial section of a rolling bearing according to the invention;

FIG. 2 is a view from the top of the rolling bearing according to FIG. 1; and

FIG. 3 is a view in axial section of an tensioning roller device according to the invention.

### DETAILED DESCRIPTION OF THE INVENTION

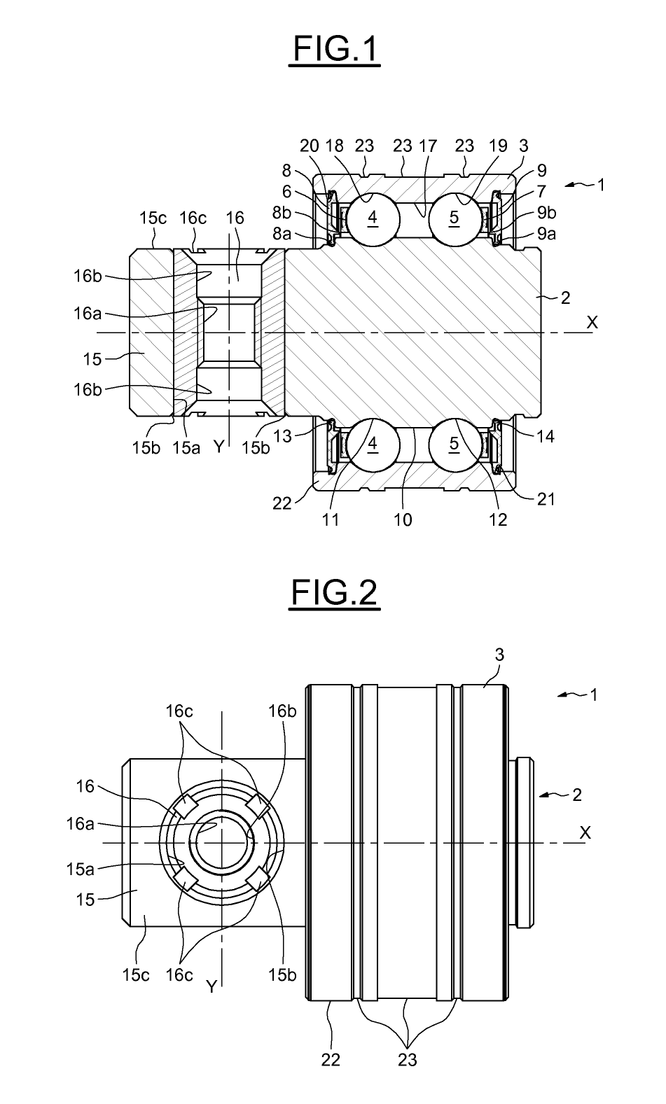

As illustrated in FIGS. 1 and 2, the rolling bearing 1, on the axis X, comprises an inner race 2, an outer race 3, two rows of rolling elements 4, 5, in this instance made in the form of balls, placed between raceways of the inner race 2 and outer race 3, two cages 6, 7 respectively maintaining the circumferential spacing of the rolling elements 4, 5, and two flanges or seals 8, 9 that are symmetrical relative to a radial plane passing between the two rows of rolling elements 4, 5.

It will be noted that it would be possible to have a single row of rolling elements placed between the races 2 and 3.

The inner race 2 forms the non-rotating portion of the rolling bearing 1 and comprises an axi-symmetric outer surface 10 in which toroidal raceways 11, 12 are made for the rolling elements 4, 5 and annular channels 13, 14 for making contact with lips 8a, 9a of the seals 8, 9. The inner race 2 also comprises an axial portion 15 extending axially, when considering the axis X of the rolling bearing 1, beyond the outer race 3. The axial portion 15 comprises an open-ended bore 15a, with an axis Y, made in the radial direction of the rolling bearing and in which an insert 16 is fitted. The bore 15a has a slight bevel 15b on its outer surface of revolution 15c, for concerns of machining the inner race 2 and for mounting the insert 16 in the inner race 2.

The insert 16 is therefore oriented in the radial direction, perpendicularly to the axis X of the rolling bearing 1.

As illustrated in FIG. 1, the insert 16 comprises a bore with a threaded central portion 16a extended radially on the side of each end by a smooth zone 16b of greater diameter than the threaded portion 16a in order to make it easier to guide a threaded rod (not shown) into the insert 16. The insert 16 comprises, at each of its ends, parallelepipedal recesses 16c, in this instance four in number, designed to interact with a crimping tool (not shown). These recesses 16c are more precisely adapted to receive the teeth of a crimping tool applying a radial force along the axis Y, so as to cause a deformation of the material in the bore of the axial portion 15 of the inner race 2, when the radial force is applied by the crimping tool. The radial force of the crimping tool also deforms the radial ends of the insert 16 so as to form a rim in the bevels 15b. Thus the deformed and pushed-away material forms anti-rotation means for the insert 16 inside the bore 15a of the inner race 2 and means for radial retention of the said insert 16. The insert 16 therefore forms an integral part of the rolling bearing 1.

As a variant, it is possible to provide other attachment means such as, for example, an attachment by braising, by welding, by bonding, or by forced sleeve-fitting of the insert 16 in the inner race 2.

It would also be possible to provide for the bore of the insert 16 to be fully tapped over the whole of its length.

The insert 16 is, as a non-limiting example, made of sintered steel or of easily-moulded steel. It may also be made of ceramic or of a plastic material with or without a glass fibre additive. The operations of machining and tapping the insert 16 are then carried out in order to obtain threading tolerances that are as satisfactory as possible.

Therefore, the threading operations are not carried out directly on the inner race 2. Moreover, the insert 16 may be mounted on the inner race 2 after the surface treatment of the latter, and notably after assembly of the other elements of the rolling bearing 1, which makes it possible to comply as closely as possible with the threading tolerances and to obtain a satisfactory perpendicularity between the axis X of the rolling bearing 1 and the axis Y of the insert 16.

The outer race 3, mounted so as to rotate about the inner race 2, forms the rotating portion of the rolling bearing 1. The outer race 3 is furnished with a bore 17 in which two toroidal raceways 18, 19 are made for the rolling elements 4, 5 and annular channels 20, 21 are made in which the seals 8, 9 are fitted. The seals 8, 9 provide a static seal with the rotating outer race 3 and a dynamic seal with the non-rotating inner race 2. The seals 8, 9 each comprise a friction lip 8a, 9a in contact with the groove 13, 14 of the inner race 2 and a non-friction lip 8b, 9b forming a seal by narrow passage with the outer race 3. Naturally, the rolling elements may be placed in a single row. The outer race 3 also comprises an axial outer surface of revolution 22 having channels 23 interacting with a pulley (not shown in the figure).

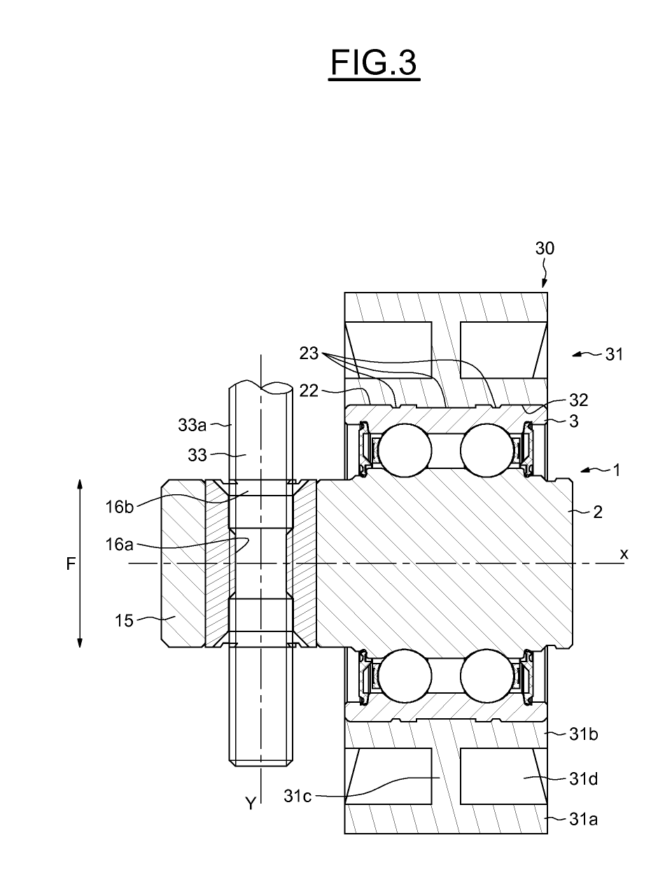

As illustrated in FIG. 3, the tensioning roller device 30 comprises a pulley 31 furnished with a ribbed bore 32 matching the shape of the channels 23 of the outer surface 22 of the outer race 3.

The pulley 31 may be obtained by an overmolding on the outer race 3 of a plastic such as a polyamide. The result of this is excellent cohesion between the parts. The annular pulley 31 has an I-shaped axial section with an outer axial portion 31a designed to be in contact with a belt (not shown), an axial portion 31b of which the bore 32 is in contact with the outer race 3, and a radial portion 31c providing the connection between the two axial portions 31a, 31b. As can be seen in FIG. 3, radial ribs 31d in the form of shelves are placed between the axial portions 31a, 31b of the pulley 32 in order to increase its radial rigidity.

As illustrated in FIG. 3, the tensioning roller 30 is usually mounted on the engine block of a vehicle (not shown) comprising a threaded rod 33 designed to interact with the tapped insert 16 in order to move, radially relative to the axis X of the rolling bearing 1, the tensioning roller 30, thus providing an adjustment in translation in the direction of the arrow F of the tensioning roller 30. The threading 33a of the threaded rod 33 matches the tapping of the insert so that the threaded rod 33, mounted on the engine by means not shown in FIG. 3, is guided into the insert 16 by the smooth zones 16b of larger diameter than the threaded portion 16a of the insert. The threaded rod 33 is then meshed into the tapping of the insert 16 so that the rotary movement of the threaded rod 33 is converted into translation movement in the direction of the arrow F of the tensioning roller device 30, thus allowing adjustment of the tension of the engine belt in contact with the pulley 31.

By virtue of the invention, the operations of threading are not directly carried out on the inner race. Moreover, the mounting of the insert on the inner race can be carried out after the surface treatment of the latter, and notably after assembly of the other elements of the rolling bearing, thus reducing the risk of a defect of perpendicularity between the axis of the rolling bearing and the axis of the threaded rod interacting with the insert. The tolerances of the threading made in the insert are also more easily maintained.

1. A rolling bearing for a tensioning roller, the bearing comprising:
an inner race,
an outer race mounted so as to rotate about the inner race, and
at least one row of rolling elements placed between the inner race and outer race, and wherein
said inner race includes an axial portion extending axially beyond the outer race and an insert fitted into an open-ended bore made in the axial portion of the inner race.

2. The rolling bearing according to claim 1, in which the axis (Y) of the open-ended bore is oriented perpendicularly to the axis (X) of the rolling bearing, so that the insert is oriented perpendicularly to the axis (X) of the rolling bearing.

3. The rolling bearing according to claim 1, wherein the insert further comprises a bore with a threaded central portion extended radially on the side of each end by a smooth zone of larger diameter than the threaded portion.

4. The rolling bearing according to claim 1, wherein the bore of the insert is tapped over the whole of its length.

5. The rolling bearing according to claim 1, further comprising two rows of rolling elements.

6. The rolling bearing according to claim 1, further comprising sealing means placed between the outer race and inner race on each side of the rolling elements.

7. The rolling bearing according to claim 1, wherein the outer race has an outer surface having channels designed to interact with a pulley.

8. The rolling bearing according to claim 1, further comprising means for attaching the insert in the inner race, allowing the anti-rotation and the axial retention of the insert.

9. The rolling bearing according to claim 8, wherein the insert further comprises, at each of its ends, recesses designed to interact with a crimping tool.

10. The rolling bearing according to claim 8, wherein the insert is attached to the inner race by one of braising, welding, bonding and forced sleeve-fitting in the inner race.

11. A tensioning roller device comprising:
a rolling bearing having an inner race,
an outer race mounted so as to rotate about the inner race, and
at least one row of rolling elements placed between the inner race and outer race, and wherein
said inner race includes an axial portion extending axially beyond the outer race and an insert fitted into an open-ended bore made in the axial portion of the inner race, and
a pulley overmolded onto the outer race.

12. The tensioning roller device according to claim 11, wherein the insert is adapted to interact with a threaded rod for the purpose of moving radially relative to the axis (X) of the rolling bearing and the tensioning roller.
